(19) United States
(12) Patent Application Publication
(10) Pub. No.: US 2006/0235922 A1
(43) Pub. Date: Oct. 19, 2006

(54) Quisquater Reduction

(75) Inventor: Gerardus Hubert, Surrey (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/528,349

(22) PCT Filed: Sep. 10, 2003
(86) PCT No.: PCT/IB03/03949

§ 371 Date: Feb. 15, 2006

(30) Foreign Application Priority Data
Sep. 20, 2002 (GB) 0221837.8

(51) Int. Cl. G06F 7/52

(52) U.S. Cl. 708/625

(57) ABSTRACT

A method and apparatus for calculating the product P of a first number X and a second number Y, modulo N, where Y is partitioned into j words each of length p bits, and has a length (m+n) bits, cyclically operates on successive ones of the j words of Y, carrying out intermediate modulo reductions of the intermediate products formed. A specially selected multiple, N′, of N is used so that only a single reduction of the intermediate based on N′ guarantees that the intermediate product P is never longer than (m+n) bits at the end of each cycle. N′ is an integer multiple of N, and the value N′ is selected such that the (m−1) most significant bits are equal to ‘1’, and the least significant bit is ‘0’.

The present invention relates to methods and apparatus for the multiplication of two long integers, modulo a third long integer. Such multiplications must be carried out repeatedly during implementation of, for example, public key algorithms in cryptographic processors.

It is therefore important to implement the multiplication operation in a manner that is most efficient in terms of time taken to perform the multiplication. In addition, it is important to be able to implement the calculations efficiently on computation hardware that often has certain practical limitations, such as a maximum word size, which may be substantially smaller than the lengths of integers being multiplied. Therefore, it is also important to provide a calculation algorithm that can efficiently perform the multiplication operation on limited hardware.

For example, in many cases it is necessary to multiply 1024 bit numbers, or even 4096 bit numbers, using hardware that is capable of handling only 32 bit wide data words. In particular, RSA encryption algorithms currently require the handling of 1024 bit numbers, which may be increased to 4096 bit numbers for improved security.

It is therefore an object of the present invention to provide a more efficient multiplication method that involves fewer calculations and therefore can implemented faster on existing hardware.

According to one aspect, the present invention provides a method for calculating the product P of a first number X and a second number Y, modulo N, where Y is partitioned into j words each of length p bits, and X has a length (m+n) bits, comprising the steps of:

a) initialising a product register, P

b) loading a first one of the j words of Y into a multiplier;

c) multiplying the loaded word of Y by X to form an intermediate product T;

d) updating the product register P with the sum of T and P*2^{p};

e) reducing the contents of the product register P by subtraction of a value P_{H}(N′/2);

f) loading a successive one of the j words of Y into the multiplier and repeating steps c) to e) for each one of the j words of Y,

wherein N′ is an integer multiple of N, and the value N′ is selected such that the (m−1) most significant bits are equal to ‘1’, and the least significant bit is ‘0’, and

wherein P_{H} is selected as the (p+2) most significant bits of P in the register.

According to another aspect, the present invention provides a processor for calculating the product P of a first number X and a second number Y, modulo N, where Y is partitioned into j words each of length p bits, and X has a length (m+n) bits, comprising:

a) initialisation means for initialising a product register, P

b) loading means for loading a first one of the j words of Y into a multiplier;

c) a multiplier for multiplying the loaded word of Y by X to form an intermediate product T;

d) update means for updating the product register P with the sum of T and P*2^{p};

e) reduction means for reducing the contents of the product register P by subtraction of a value P_{H} (N′/2);

f) control means for loading successive ones of the j words of Y into the multiplier and repeating the functions of the multiplier, the update means and the reduction means for each one of the j words of Y,

wherein N′ is an integer multiple of N, and the value N′ is selected such that the (m−1) most significant bits are equal to ‘1’, and the least significant bit is ‘0’, and

wherein P_{H} is selected as the (p+2) most significant bits of P in the register.

Embodiments of the present invention will now be described by way of example and with reference to the accompanying drawings in which:

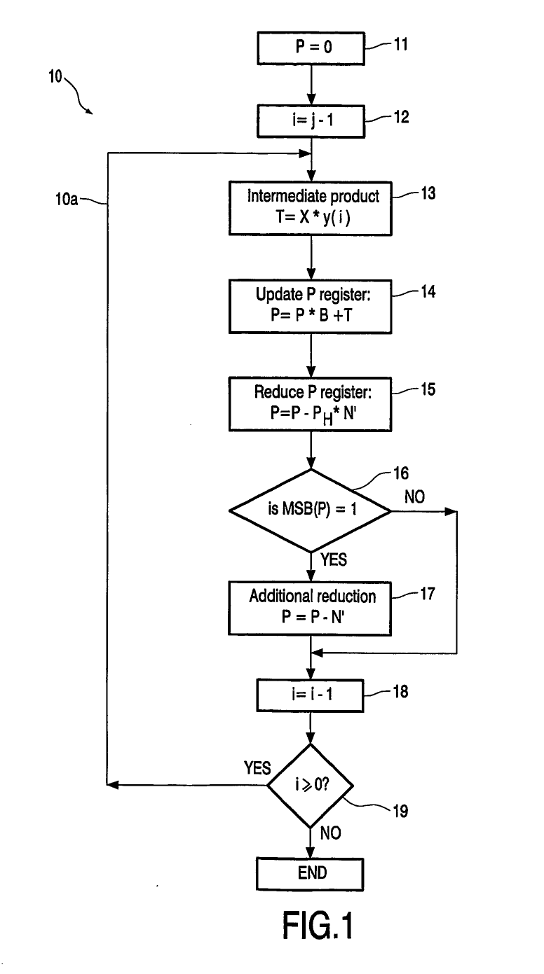

FIG. 1 shows a flow diagram illustrating a conventional Quisquater reduction algorithm;

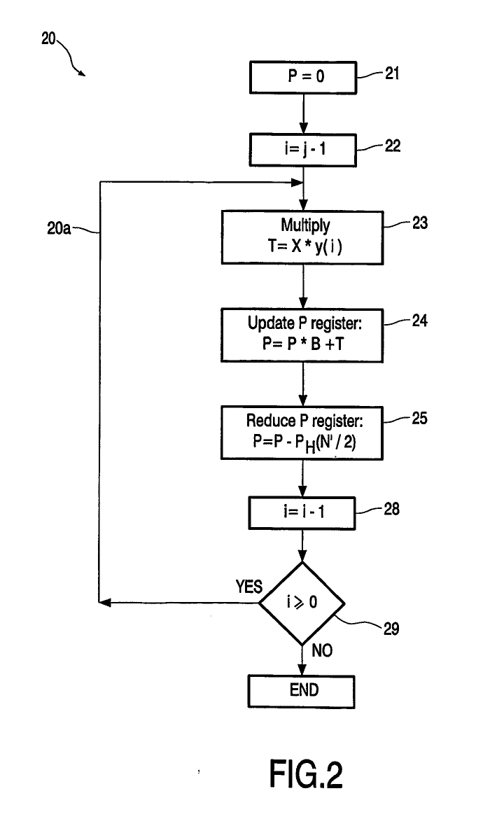

FIG. 2 shows a flow diagram illustrating an improved Quisquater reduction algorithm;

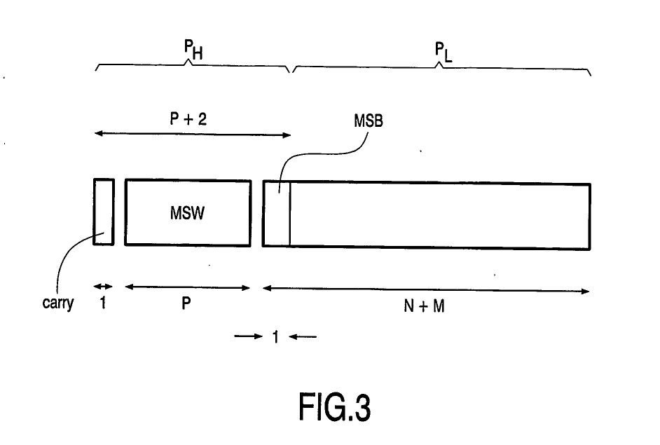

FIG. 3 shows a schematic diagram of the layout of the product P and its component parts P_{H} and P_{L} prior to the reduction operation; and

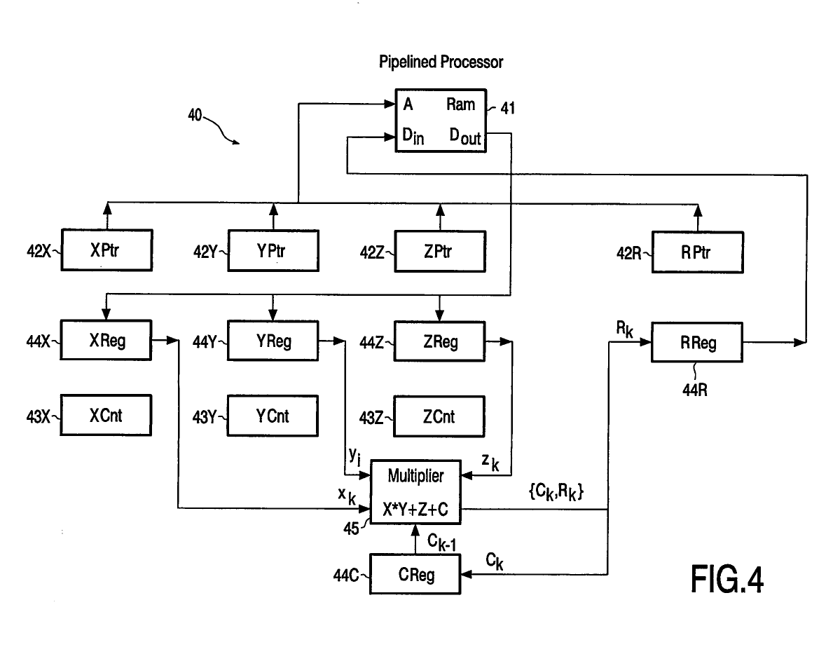

FIG. 4 shows a schematic diagram of a pipelined processor implementing the algorithm of FIG. 2.

A calculation that must be performed many thousands of times during, for example, RSA or ECC public key operations is the determination of the product:
P=X*Y mod N,
where X, Y and N are all long integers of length (m+n) bits. In a conventional manner, the long integers X and Y are handled as p-bit words (typically 32 bit words). Partial products may be calculated using a suitably sized multiplier, preferably sized appropriately to handle the word size, eg. a p*p multiplier.

As now described with reference to FIG. 1, in a conventional Quisquater reduction scheme 10, the calculation performed is:
P=X*Y mod N′
where N′ is chosen as a multiple of N, ie. N′=I.N where I is an integer. Further, N′ is specially chosen such that the m most significant bits are ‘1’ and N′ is (n+m) bits wide:

$${N}^{′} = {111 … 1}^{← m \to } {{N}_{n - 1} {N}_{n - 2 …} {N}_{0}}^{← n \to }$$

The product P and its reduction modulo N′ is calculated according to the following algorithm:
B=2^{p} (for example, p=32)

$$Y = {\sum }_{i = 0}^{j - 1} {y}_{i} * {B}^{i}$$

where yᵢ is the ith p-bit word of Y, and j is the number of p-bit words in Y (ie. j*p=(m+n)).

| P = 0; | |
|---|---|
| for i = j − 1 downto 0 | |
| { | T = X * y(i) |
| | P = P * B + T |
| | P = P − (P_{H} * N′) // reduction of P |
| | if msb(P) = 1 then P = P − N′ |

}

With reference to FIG. 1, P is initialised to zero (step 11), and a for-loop 10a is initialised (step 12) with control parameter i=(j−1).

In step 13, intermediate product T is calculated as X*y(i). X is (n+m) bits wide, y(i) is p bits wide, so the product T is (n+m+p) bits wide. This can be computed either in one pass using an (n+m)*p bit multiplier, or X can be handled in fragments using a smaller multiplier. For example, if X is also broken into j p-bit words, then X*y(i) can be calculated using a p*p bit multiplier. For other reasons described later, use of a (p+1)*p bit multiplier may be preferred.

In each cycle of the for-loop 10a, P starts (n+m) or fewer bits wide, so the product P*B is (n+m+p) bits wide. After the addition of T (step 14), P is at most (n+m+p+1) bits wide before the reduction operation 15. At this stage, P can be written as P_{H}.2^{n+m}+P_{L}, where P_{H} is the upper (p+1) bits of P, while P_{L} is the remaining lower (m+n) bits of P. For the modulo reduction, the size of P can be reduced by subtraction of a multiple of N′, in a first reduction operation comprising subtraction of P_{H}*N′.

After the first subtraction of (P_{H}*N), P will be (m+n+1) bits wide at most. When the highest bit is 1 (checked in step 16), then an additional subtraction operation P=P−N′ is required (step 17) which again reduces P to (m+n) bits in length. At this point, the value of i is decremented (step 18) and the loop 10a is repeated until j cycles have completed under the control of step 19.

In this algorithm, the reduction of P in each loop 10a requires the test (step 16) to see whether the additional subtraction operation (step 17) is necessary. In typical implementations, m is large and the additional subtraction operation P=P−N′ of step 17 is very rarely required. Thus, the operation of step 16 to check for its necessity is largely a wasted operation.

It can be shown that the additional subtraction operation will be required when at least all of the upper (m+n)−(p+1+n), ie. m−p−1, bits are ‘1’.

The chance of this occurring is 2^{-(m-p-1)}. Further, the summation of the remaining (m+n) bits must also give an overflow. The chance of that overflow occurring is (2^{(m+n)}−1)/2^{(m+n+1)} which can be approximated for all usual values of m and n by 0.5. Thus, the total chance of requiring the additional subtraction step 17 is 2^{-(m-p-1)}*0.5=2^{-(m-p)}.

In a typical application, m=63 and p=32, so the number of occasions on which the additional subtraction operation has to be performed is typically only 1 in 2×10⁹.

Thus, it will be seen that incorporation of the logic necessary to check whether the additional subtraction is necessary represents a significant processing overhead for an event that is very rarely required.

Particularly when the algorithm 10 is implemented using a pipelined multiplier, it will be observed that the start of a new multiplication operation (steps 13 and 14) cannot commence until the end of the reduction operations (steps 15 to 17). This is because it must be established (step 16) whether the further reduction operation (step 17) is required, by checking the most significant bit of P, before the next multiplication operation can commence.

With reference to FIG. 2, a modification 20 to the algorithm 10 of FIG. 1 is now described in which a value of N′ is specially selected such that it is guaranteed that the maximum size of P at the end of each cycle will be no larger than (m+n) bits without the need for the additional reduction operation.

This offers a considerable processing advantage, in that the checking of the most significant bit of P after the initial reduction operation is not required, and there is no need for a pipelined processor to wait for the end of the reduction operation before commencing the multiplication operation for the next cycle.

N′ is specially selected, again as an m+n bit integer, but in which the m−1 most significant bits are ‘1’ and the least significant bit is ‘0’, so that N′ is even:

$${N}^{′} = {111 … 1}^{← m - 1 \to } {{N}_{n - 1} {N}_{n - 2 …} {N}_{1}}^{← n \to } {0}^{1}$$

The product P and its reduction modulo N′ is calculated according to the following algorithm, which Y is split into j chunks each of length p-bits:
B=2^{p} (for example, p=32)

$$Y = {\sum }_{i = 0}^{j - 1} {y}_{i} * {B}^{i}$$

where yᵢ is the ith p-bit word of Y, and j is the number of p-bit words in Y (ie. j*p=(m+n)). In this scheme, p≦m−3.

| P = 0; | |
|---|---|
| for i = j − 1 downto 0 | |
| { | T = X * y(i) |
| | P = P * B + T |
| | P = P − P_{H}(N′/2) // reduction of P |

}

With reference to FIG. 2, P is initialised to zero (step 21), and a for-loop 20a is initialised (step 22) with control parameter i=(j−1).

In a multiplying step 23, intermediate product T is calculated as X*y(i). X is (n+m) bits wide, y(i) is p bits wide, so the product T is (n+m+p) bits wide. This can be computed either in one pass using an (n+m)*p bit multiplier, or X can be handled in fragments using a smaller multiplier. For example, if X is also broken into j p-bit words, then X*y(i) can be calculated using a p*p bit multiplier, or a (p+1)*p bit multiplier. However, for reasons that are discussed later, in the preferred embodiment, a (p+2)*p bit multiplier is used when both X and Y are handled as j words, x(k) and y(i), where i=0 . . . (j−1) and k=0 . . . (j−1).

In each cycle of the for-loop 20a, P starts (n+m) or fewer bits wide, so the product P*B is (n+m+p) bits wide. In step 24, the P register is updated by the addition of T. After the addition of T (step 24), P is at most (n+m+p+1) bits wide before the reduction operation 25.

At this stage, P can be written as P_{H}*^{2(n+m-1)}+P_{L}, where P_{H} is the upper (p+2) bits of P, while P_{L} is the remaining lower (m+n−1) bits of P. A factor k=P_{H}/2 is used as an estimation of the multiplying factor for N′ used in the reduction operation 25. In this case, reduced P′=P−(P_{H}/2)*N′, or, as in step 25, P=P−P_{H}*N′/2. Because P_{H} might be odd, N′ is selected to be even so that N′ is divisible by 2.

After the first subtraction of P_{H}*N′/2, P will be (m+n) bits wide under all circumstances. Therefore, unlike the algorithm of FIG. 1, no most significant bit check or further subtraction operation is required. At this point, the value of i is decremented (step 28) and the loop 20a is repeated until j cycles have completed under the control of step 29.

In a presently preferred embodiment, step 25 is actually performed as an addition operation, by using:

P=P+P_{H}*M,

where M=−N′/2 in its two's complement form.

This addition may also be broken into a number of words (eg. j words of p bits). More generally, if P is broken into q words of size p, then for each of the words, P(k), where k=0 . . . (q−1):

{C(k), R(k)}=P(k)+P_{H}*M(k)+C(k−1)

where P(k) is the kth word of P, M(k) is the kth word of M, R(k) is the least significant word of the calculation result and C(k) is the upper remaining bits (most significant word) of the multiplication result, which are added as C(k−1) in the subsequent calculation for the next significant word. Proof of proper reduction of P by step 25, such that P will always be non-negative and always reduced to a maximum size of (m+n) bits is given below.

P is Never Negative

P is at minimum when N′ is at maximum, i.e. N′=2^{m+n}−2.

Then we must prove that P′>0.

$$\begin{matrix}P = {P}_{H} {.2}^{n + m - 1} + {P}_{L} - {P}_{H} . ( {2}^{m + n} - 2 ) / 2 \\ = {P}_{L} + {P}_{H} .\end{matrix}$$

Because both P_{L} and P_{H} are both non-negative, P′ is also non-negative.
P is (m+n) Bits Wide
P is at maximum when N′ is at minimum, i.e. N′=2^{m+n}−2ⁿ⁺¹.

$$\begin{matrix}P = {P}_{H} {.2}^{n + m - 1} + {P}_{L} - {P}_{H} . ( {2}^{m + n} - {2}^{n + 1} ) / 2 \\ = {P}_{L} + {P}_{H} * {2}^{n}\end{matrix}$$

P_{L} is (m+n−1) Bits Wide
P_{H}*2ⁿ is (p+2+n) Bits Wide
Because p≦m−3, P is at Most (m+n) Bits Wide.

As indicated above, it is a condition is that m≧p+3. To calculate P_{H} easily, it is preferred that m+n should be a multiple of p bits. P_{H} is then computed from the carry of the addition, the most significant word of the addition and the most significant bit of the most but one significant word.

The layout of P after the multiplication stages, P=P*B+T, of maximum (n+n+p+1) bits is shown in FIG. 3. P_{H} is established using bit positions of Pₙ₊ₘ₋₁, Pₙ₊ₘ, Pₙ₊ₘ₊₁, . . . Pₙ₊ₘ₊ₚ, Pₙ₊ₘ₊ₚ₊₁.

When the prime N is 160 bits or less, then for a 32-bit system (p=32), the number of 32-bit words to calculate with is 7. Therefore m can also be chosen as 64, without sacrificing performance.

For a prime N with length of 157 bits or less and also for some primes with length between 158 and 160 bit, N′ (=197 bits) can be chosen such that the upper (m−1) bits are all ‘1’. This means that the number of words to calculate with is 6 instead of 7. Because the length of P_{H} is (p+2) bits, in the preferred embodiment, a (p+2)*p multiplier is used, instead of the minimum requirement of a p*p multiplier. In this instance, the multiplication of N′ by P_{H} does not have to be split and the number of multiplications is reduced.

With reference to FIG. 4, an exemplary pipelined processor 40 implementing the algorithm of FIG. 2 is now described. In the processor 40, all operands (X, Y and product P, referred to in FIG. 4 as “Z”) are stored in a memory 41 during processing and are accessed according to memory addresses provided on input “A” as provided by pointer registers to be described. Data is read from the memory 41 on data line “Dout” and written to memory on data line “Din”. A suitable control circuit, eg. state machine (not shown) maintains correct sequence of operation of the processor 40.

The words x(k) of operand X are stored in memory 41 at addresses pointed to by XPtr register 42X. Similarly, the words y(i) of operand Y are stored in memory 41 at addresses pointed to by YPtr register 42Y. The words z(k) of the product and operand Z are stored in memory at addresses pointed to by ZPtr register 42Z. Values of the word positions, i and k, in the operands and product are stored in respective counters XCnt, YCnt and ZCnt shown at 43X, 43Y and 43Z respectively. The addresses in XPtr, YPtr and ZPtr may indicate a base address plus an offset that can be deduced from the counters XCnt, YCnt, ZCnt.

For each relevant operation, the next word of X, Y and Z is retrieved from memory 41 under the control of the pointers 42 and counters 43, and respectively stored in one of the registers XReg, YReg and ZReg, labelled 44X, 44Y and 44Z respectively. Each time a word is retrieved to a register 44, the respective counter 43 is incremented or decremented accordingly.

The least significant word of the result R of each multiplication of a word of X, Y or Z is passed to an RReg register 44R, and will be stored in memory 41 at the address indicated by pointer RPtr designated 42R. The carry bits, ie the most significant word of the result, C is passed to a CReg register 44C ready for use in a subsequent multiplication.

Multiplier 45 received word inputs x(k), y(i), z(k) and c(k) for each multiplication operation, as required.

At the start of a new for-loop 20a (FIG. 2), CReg is initialised to 0. Then, at every multiplication (ie. for each value of k within the for-loop in steps 23 and 24), the most significant word of the previous result (C(k−1) is added to the kth multiplication of x(k) and y(i). It will be recalled that i is updated once for each for-loop 20a, whereas k is updated for each of the j words of X within each pass of the for-loop 20a. Step 23 (T=X*y(i)) and step 24 (P=P*B+T) are effectively combined but are executed on a word by word basis for all x(k).

On most occasions, z(k) input to the multiplier (step 24) is the same as the previous stored R in register 44R, shifted by one word (multiplication by B=2^{p}) but not during the reduction step 25.

Counters 43 count down the number of words used for each series of multiplications. Of course, counters 43X and 43Z count down from k=(q−1) . . . 0 for each pass through for-loop 20a, while counter 43Y decrements once for each through the for-loop 20a. Counters 43X and 43Z are therefore reset after each pass through the for-loop 20a. Counters 43X and 43Z could, in the preferred embodiment be combined.

At the end of each series k=(q−1) . . . 0, there will be one more multiplication with x(k)=0 which reduces the multiply operation to R(k)=z(k)+C(k−1) which is the last result to be stored. C(k) will always be 0 in the last result. Then, the subtraction step (step 25) with different operators may be started (or the equivalent addition as discussed previously). This may be performed using the same multiplier 45.

In the present invention, during the reduction step 25, the next values of X and Y can always be loaded, but this is not the case in the conventional scheme of FIG. 1 because of the possibility of a further reduction step 17.

Other embodiments are within the scope of the appended claims.

1. A method for calculating the product P of a first number X and a second number Y, modulo N, where Y is partitioned into j words each of length p bits, and X has a length (m+n) bits, comprising the steps of:
a) initialising a product register, P
b) loading a first one of the j words of Y into a multiplier;
c) multiplying the loaded word of Y by X to form an intermediate product T;
d) updating the product register P with the sum of T and P*2^{p};
e) reducing the contents of the product register P by subtraction of a value P_{H} (N′/2);
f) loading a successive one of the j words of Y into the multiplier and repeating steps c) to e) for each one of the j words of Y,
wherein N′ is an integer multiple of N, and the value N′ is selected such that the (m−1) most significant bits are equal to ‘1’, and the least significant bit is ‘0’, and
wherein P_{H} is selected as the (p+2) most significant bits of P in the register.

2. The method of claim 1 in which the second number Y is also (m+n) bits in length.

3. The method of claim 1 further including the step of selecting m≧p+3.

4. The method of claim 1 further including the step of selecting (m+n) as a multiple of p bits.

5. The method of claim 1 further including the step of using a (p+2)*p multiplier to perform the multiplying step and for deriving the value P_{H} (N′/2).

6. The method of claim 1 in which the first one of the j words of Y loaded into the multiplier is the most significant word, and successive ones of the j words are loaded in decreasing order of significance.

7. The method of claim 1 carried out in a pipelined processing architecture, in which the multiplication step for a successive cycle through steps c) to e) commences prior to completion of the subtraction step e) of a preceding cycle.

8. A processor for calculating the product P of a first number X and a second number Y, modulo N, where Y is partitioned into j words each of length p bits, and X has a length (m+n) bits, comprising:
a) initialisation means for initialising a product register, P
b) loading means for loading a first one of the j words of Y into a multiplier;
c) a multiplier for multiplying the loaded word of Y by X to form an intermediate product T;
d) update means for updating the product register P with the sum of T and P*2^{p};
e) reduction means for reducing the contents of the product register P by subtraction of a value P_{H} (N′/2);
f) control means for loading successive ones of the j words of Y into the multiplier and repeating the functions of the multiplier, the update means and the reduction means for each one of the j words of Y,
wherein N′ is an integer multiple of N, and the value N′ is selected such that the (m−1) most significant bits are equal to ‘1’, and the least significant bit is ‘0’, and
wherein P_{H} is selected as the (p+2) most significant bits of P in the register.

9. The processor of claim 8 in which the second number Y is also (m+n) bits in length.

10. The processor of claim 8 in which m≧p+3.

11. The processor of claim 8 in which (m+n) is an integer multiple of p bits.

12. The processor of claim 8 in which the multiplier is a (p+2)*p multiplier also adapted to provide the value of P_{H} (N′/2) to the reduction means.

13. The processor of claim 8 in which the loading means is adapted to load the most significant word of Y as the first one of the j words of Y loaded into the multiplier, and successive ones of the j words are loaded in decreasing order of significance.

14. The processor of claim 8 implemented in a pipelined processing architecture, in which the multiplier commences the multiplication operation to obtain a new value of T for a successive cycle prior to the reduction means completing the reduction of the contents of P for a preceding cycle.

15. A computer program product, comprising a computer readable medium having thereon computer program code means adapted, when said program is loaded onto a computer, to make the computer execute the procedure of any one of claims 1 to 7.
